(19) United States
(12) Patent Application Publication
(10) Pub. No.: US 2010/0304721 A1
(43) Pub. Date: Dec. 2, 2010

(54) Signalling of Extended Mobile Station Capabilities to a Mobile Communication Network

(76) Inventor: Srdjan Krco, Dublin (IE)

Correspondence Address: POTOMAC PATENT GROUP PLLC, P. O. BOX 270, FREDERICKSBURG, VA, 22404, US

(21) Appl. No.: 12/599,054

(22) PCT Filed: May 8, 2007
(86) PCT No.: PCT/EP2007/054454

§ 371 Date: Jan. 30, 2010

(51) Int. Cl. H04W 4/00

(52) U.S. Cl. 455/414.1

(57) ABSTRACT

The present invention relates to an information element and a method for informing a network about the capabilities of at least of network node. The element is adapted for containing at least one predefined field comprising a parameter which defines a general characteristic of the network node. The element is further characterized in that at least one of the parameters being a role parameter relating to the capability and requirements of the network node in a role as an information provider. The role comprises the capability of forwarding information from a data storage and/or collecting unit to the network.

### TECHNICAL FIELD

The present invention relates to an information element and a method for informing a network about the capabilities of at least of network node.

### BACKGROUND

In 3G (third generation mobile phone standard) networks today, each MS (Mobile Station), in 3G called UE (User Equipment), when activated goes through a set of registration and attach procedures with the mobile network before the end user can make a call or use some other mobile service. During these activities the MS informs the network of their IMSI number and other specific MS capabilities for this particular MS and get appropriate network identifications that are used for subsequent call establishments.

The first time SIM is activated, the IMSI needs to be defined in the AuC (Authentication Centre) in order to activate the subscription by authenticating the SIM-card that attempts to connect to the network. If the authentication is accepted, the HLR (Home Location Register) or the VLR (Visitor Location Register) will manage the SIM-card and generate an encryption key for the normal communication (to avoid eavesdroppers). If the authentication is not accepted, no communication between the SIM-card and the network is accepted

In order to inform the network about the MS capabilities a MS network capability information element is used, see FIG. 1. This is defined in the 3GPP (3rd Generation Partnership Project) technical specification TS24.008. This element contains a number of fields with a predefined set of possible values of parameters which define general mobile station characteristics. Examples of the defined fields are:
SM (Statistic Multiplexing) capabilities via GPRS channel
UCS2 (2-byte Universal Character Set) support
GPRS (General Packet Radio Service) encryption algorithm
PFC (Packet Flow Context) feature mode, etc.

In general, an information element is a data packet of a particular length which has been encoded by a communication protocol for transmission over a node-to-node link. Each element comprises useful information for transmission from one node to another. In the MS network capability information element of this particular kind, the structure is shown in FIG. 1 wherein IEI is the information element identifier which defines the information element that is being sent. In the second octet (Octet 2) the network is informed about the length of the MS network capability contents. The third octet (Octet 3) comprises the MS network capability value, which is the content that the second octet refers to.

The MS Radio Access capability information element is another information element that provides the radio part of the network with information concerning radio aspects of the mobile station. This is shown in FIG. 2 and has the same structure as the network capability element, see FIG. 1. The contents of this information element might affect the manner in which the network handles the operation of the mobile station. Some of the fields defined in this particular information element are:
Access Technology Type,

RF (Radio Frequency) Power Capability
8PSK (Phase Key Shifting—a type of modulation used) Power Capability,
PS (Pseudo Synchronization)
VGCS (Voice Group Call Service)
GPRS (General Packet Radio Service) Multi Slot Class

Mobile stations (User Equipment) in today's networks are considered as devices that end users use to access services that network provides. Such services were in the history voice calls and later SMS and MMS. In the high speed 3G networks such services also relates to data access, for instance to email and internet. The role of the mobile phone is consequently changing and it has become a multifunctional device that can be used not only to access network services, but also to provide services.

There is now a possibility to connect new functionality, for instance in form of a separate unit, to the phone. Examples of such separate unit are cameras and sensors that can be used in health care. The role of the MS in health care is continuously increasing and there is an interest to use the MS as a personal health check devices that can be connected over mobile networks to health professionals to forward them relevant patient's health data. In such a role sensors connected to the MS could perform different kind of measurements, such as blood oxygen saturation, blood pressure, presence of infections etc. The sensor may be built into the phones or located in the vicinity of a phone and accessible via a short range wireless interface like Bluetooth. Since the MS also already contains a remote camera, the accessibility by anyone in need of a photo or a video recording of a certain area is another obvious functionality. Other areas are in the areas of sharing music or offering information about the prices and special offers in a shopping mall gathered via a built-in RFID reader. Another example of such mobile phone functionality is in the area of wireless sensor networks. When connecting a sensor to the mobile phone, the phone can serve as a sensor network gateway.

Hence, the MS can now provide various services to other users. The mobile phones are becoming not only devices used to access services but also to provide a variety of services to other mobile network users. In addition the number of M2M (Machine to Machine) systems in use is steadily increasing and this type of communication will be one of the main drivers of the mobile networks development in the future. In such a system, there will be a variety of information produced by mobile stations that is then made available to interested users.

This means that in a ubiquitous sensor environment, the MS will be responsible for the provision of access to sensor network information. As such a provider, the MS-will have to inform the network so that the network can update configuration information accordingly, for instance by setting up:
Specific RABs (Radio Access Bearer)
Specific charging models
Updating database of sensor network gateways that can be queried.

This information is then used to inform potential users of this sensor network information of the existence of sensors in the network as well as for optimization of network configuration and utilization of the network resources.

A problem is that in the current 3GPP framework there is no effective mechanism in the network today to in an effective manner optimize utilizing a limited set of radio bearers, optimize the network configuration and utilize scarce radio resources when introducing such service providers.

### SUMMARY

The object of the present invention is therefore to provide a way of improve the communication between the network and the mobile station when introducing a service provider.

The object is achieved by means of a information element adapted for containing at least one predefined field comprising a parameter which defines a general characteristic of the network node. The element is further characterized in that at least one of the parameters being a role parameter relating to the capability and requirements of the network node in a role as an information provider. The role comprises the capability of forwarding information from a data storage and/or collecting unit to the network.

The object is further achieved by means of a method for informing a network about the capabilities of at least of network node. An information element is adapted for containing at least one predefined field comprising a parameter which defines a general characteristic of the network node. The method is further characterized in that the network node processes at least one parameters being a role parameter relating to the capability and requirements of the network node in a role as an information provider. In said role the network node forwards information from a data storage and/or collecting unit to the network.

The advantageous effect of the present invention is that the network will no longer treat each mobile station equally as service users, but will be able to optimize configuration utilizing particular requirements and capabilities of each MS. With the present inventions the usage of the network will be optimized. The network will know what each mobile station is capable of and what the station will know what it can expect from the network. This information can also be used to optimally allocate available radio resources, for instance when a connection admission algorithm takes this information into account when granting network access to a particular user.

Moreover, in such a ubiquitous service/information provider environment it will be crucial to enable easy service deployment, discovery and provision. By embedding the essential service information into the mobile station attach procedure the automatic setup of services is facilitated. The network will be informed of the existence of mobile stations that primarily serve as sources of information. Furthermore, information related to service setup is exchanged in the initialization period with a minimum overhead.

Network operators will also be able to use provided information to optimize network resources. For example, if a mobile station is a sensor network gateway, the operator can charge more or less depending on the business model. The operators will also be able to provide that information to sensor network service operators.

### BRIEF DESCRIPTION OF DRAWINGS

The present invention will now be described more in detail with reference to the appended drawings:

FIG. 1 schematically shows the structure of an information element for the network node network capabilities.

FIG. 2 schematically shows the structure of an information element for the network node radio access capabilities.

FIG. 3 schematically shows the role of the network node as service provider.

FIG. 4 schematically shows the structure of an information element for the network node role capabilities.

FIG. 5 schematically shows the communication between the network node and the network.

### DETAILED DESCRIPTION

The information element and the method for informing a network about the capabilities of at least one network node will now be described with reference to an embodiment.

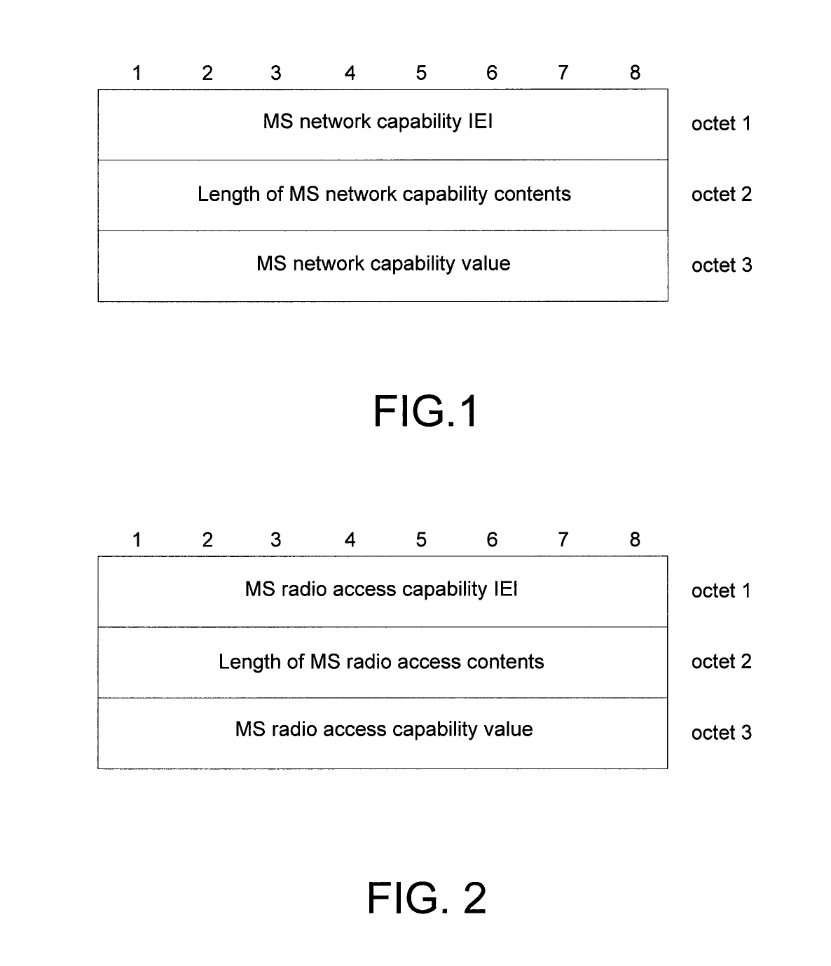

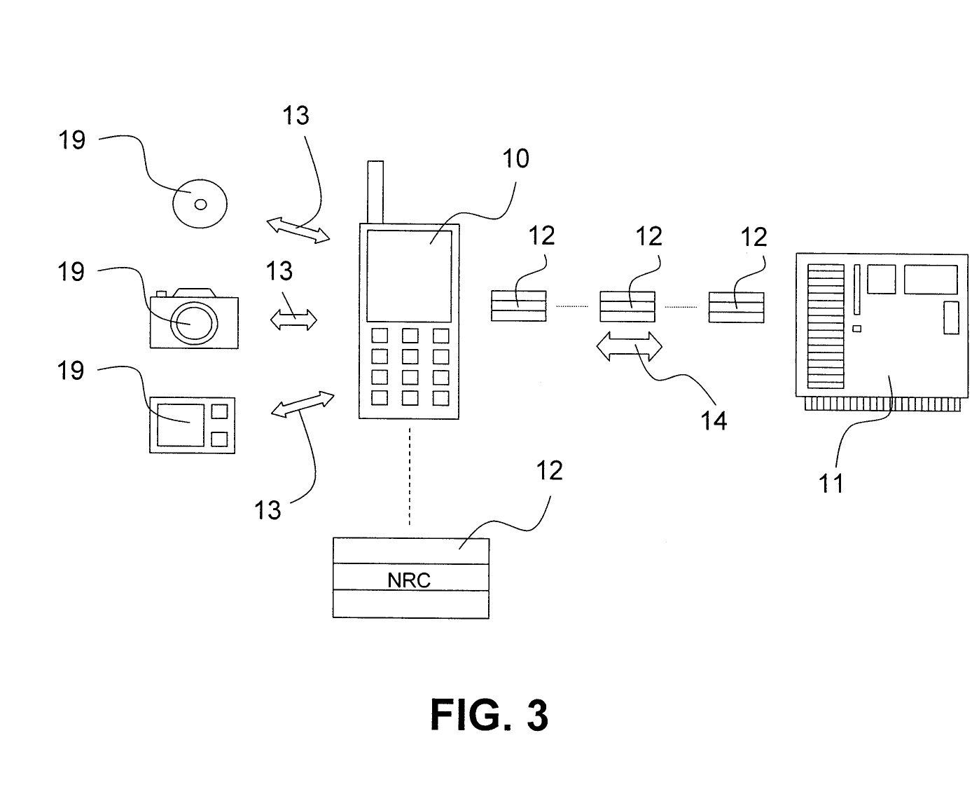

In FIG. 3 a network node 10, in form of a mobile station (mobile phone) is shown. The node communicates 14 wirelessly with a network 11 in form of a cellular network. According to the known prior art, the node uses at least one information element containing at least one predefined field comprising a parameter which defines the characteristics of the node. Each field defines a specific parameter. Such elements are the MS Network capability information element, see FIG. 1, and the MS radio access capability element, see FIG. 2. The elements are sent to the network, see FIG. 3, to inform about the characteristics of the node so that the network can handle the operation of the network node.

What particularly characterizes the present invention is the new information element 12 introduced to inform the network 11 about the capability of the network node 10 to act in a role as an information provider. The new information element contains at least one role parameter relating to the capability and the requirements of the node in such a role. The information element solely contains said role parameters and/or information about said role. As an alternative, the role parameters can be introduced in already present information elements, which mean that the element contains said role parameters and/or information about said role and also parameters which defines other characteristics of the network node such as network capability information and/or radio access capability information, see FIG. 1-2.

The new role relates to the capability of forwarding information from a data storage and/or collecting unit 19 to the network. In FIG. 3 the units 19 are represented by different symbols. The role for instance consists in acting as network gateway for said forwarding of information. The network node acts as a network gateway when forwarding information from the units in the vicinity of the node (sensors attached wirelessly to the node for instance). When the node is a mobile station and the unit (sensor, camera, vending machine etc) is built into the node, the station on its own will be a service provider. This still means that information is forwarded from the unit to the network.

A data storage and/or collecting unit is for instance a wireless sensor gateway, a medical device, an M2M device, a music sharing server, a camera, a blood pressure or blood sugar level monitor, a vending machine, an electricity or gas meter monitor device, a vehicle location tracking device or an environmental sensor network gateway. The network node 10 can now act in a role as information provider which means that it can provide various services to other users.

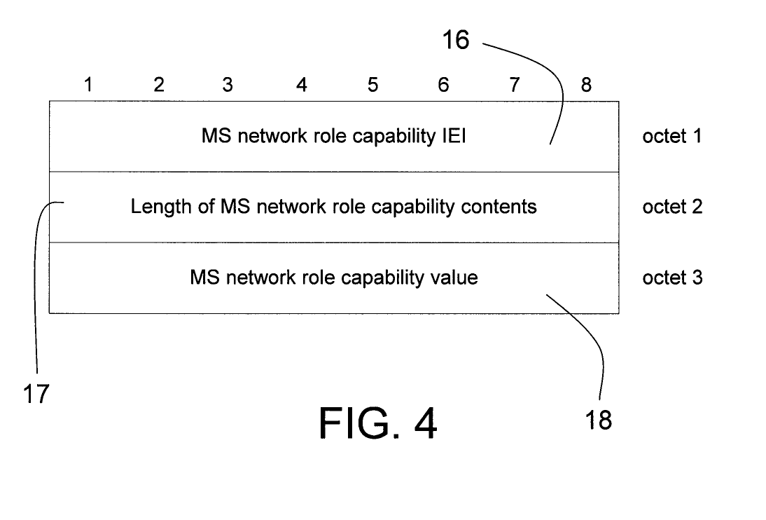

The communication with such units means that data, for instance medical data as ECG and blood pressure can be forwarded to the medical expert for diagnose. Other data that can be forwarded is music files, digital photos, vending machine information, charge information, electricity or gas information or environmental sensor information. The content of the information element 12 will now be described in relation to FIG. 4. The structure of the element is the same as for the elements of FIGS. 1 and 2.

According to FIG. 4, the information element contains a first octet 16 (MS network role capability IEI) comprises at least one parameter that defines the identity (IEI means Information Element Identity) of the information element 12. The second octet 17 (Length of MS network role capability contents) comprises at least one parameter that defines the length of the element containing at least one role parameter.

One information element can have various lengths depending on the number of optional fields defined for that information element. Therefore octet 2 defines the length so that the receiving side can determine the boundaries of an information element. Inside the information element, there is a number of fields. The fields can have different lengths (different number of bytes) depending of information they are supposed to convey.

The third octet 18 (MS network role capability value) comprises one field (MS Type) with at least one role parameter that defines the type of data storage and/or collecting unit 19. In accordance with the present embodiment this role parameter is one byte long where the four most significant bits defines the major device unit representing the type of data and the four least significant bits defines the minor device unit representing the type of unit. As an alternative the field may be longer or shorter and the role of the particular bits may be different. The major device unit type of data is for instance wireless sensor network gateway data, medical device data, M2M (Machine to Machine) data, music sharing server data or camera data. The minor device type of unit defines the device more in detail and is for instance ECG, blood pressure or blood sugar level monitor, vending machine, electricity or gas meter monitoring device, vehicle location tracking device or environmental sensor gateway.

The third octet 18 further comprises one field (Network capability) with at least one role parameter that defines the network resource or resources that the network node can use for facilitating a better network utilization. Such a network resource for instance can be a list of RABs (Radio Access Bearer) that the network node is capable of using. In many cases this is a very limited set of network functions which will enable adequate optimization of network resources utilization (for example combined transmission of multiple mobile stations payloads, scheduling of data).

The third octet 18 finally comprises one field (Service profile) with at least one role parameter that defines the service or services that the network node can provide. Such definitions are for instance the name of the service, an unique identifier for authentication the network node to the network (this is optional) and/or the address (for example URL) of the central service provider that the MS will be forwarding data to. As an example the vending machines might come with a pre-programmed service provider information that is centrally managing all machines in the field. At least one parameter is said field also defines the version of a service discovery protocol to be used by a remote user of the service or services for querying the network node 10 so that service profile information is obtained (the cost, availability, accuracy, etc.). Depending on the type of service a mobile station is providing, different service discovery protocol might be used.

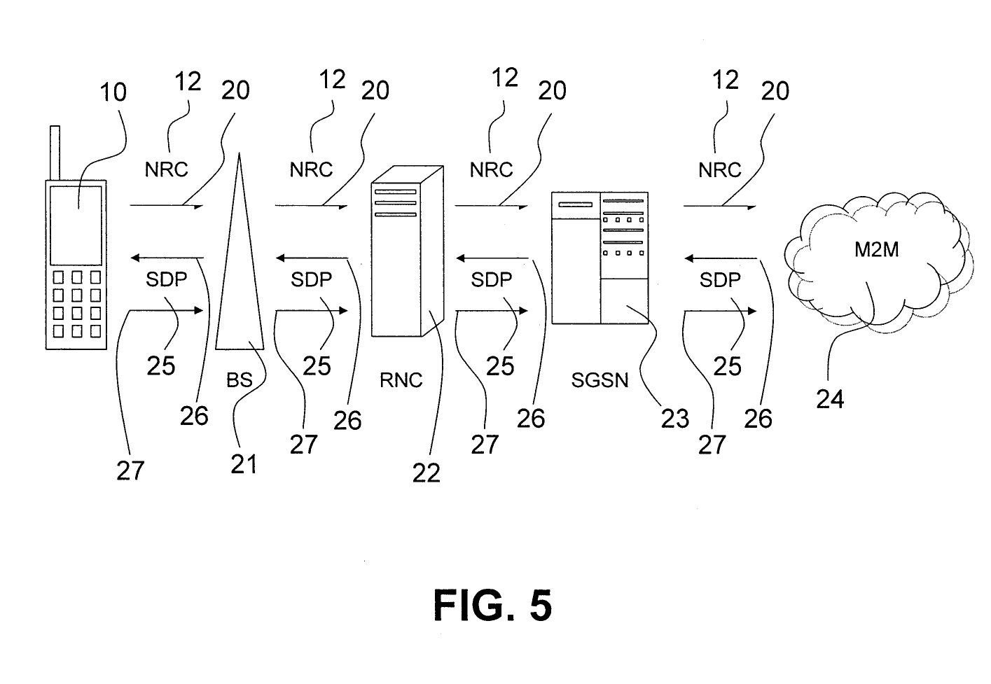

The method for informing a network about the capabilities of at least one network node will now be described with reference to FIG. 5. The information element 12 contains parameters with a predefined set of values which defines the characteristics of the node. Such elements are the MS Network capability information element, see FIG. 1, and the MS radio access capability information element, see FIG. 2. The elements are sent to the network, see FIG. 3, to inform about the characteristics of the node so that the network can handle the operation of the network node.

What particularly characterizes the present invention is that the network node 10 processes at least one role parameter relating to the capability and the requirements for the node in such a role. The processing consists in the defining of the role parameter. A new information element 12 is introduced, comprising the role parameter/-s to inform the network 11 about the capability of the network node 10 to act in a role as a service provider. As an alternative, role parameters can be introduced in already present information elements, which mean that the element contains said role parameters and/or information about said role and also parameters which defines other characteristics of the network node such as network capability information and/or radio access capability information, see FIG. 1-2.

The processing is activated when a data storage and/or collecting unit 19 starts to communicate 13 with the network node 10. Role parameters that are processed are at least:
one defining the identity of the element,
one defining the length of the fields contained in the information element,
one defining the type of data storage and/or collecting unit,
one defining the network resource or resources used by the network node for facilitating a better network utilization,
one defining the service or services the network node can provide,

According to one embodiment the information element 12 (NRC—Network Role Capability Information Element) comprising the processed role parameter/-s is during an attach procedure transmitted 20 to a Radio Network Controller 22 (RNC) and further to the core network via a base station 21 (BS). In this way the network is informed about the capabilities and the role/-s of the network node 10. The network related capabilities are processed in the network node and as such will impact the manner in which the network handles the operation of the network node.

The information element 12 (NRC) is further transmitted 20 via a Serving GPRS Support Node 23 (SGSN) to a network system 24 in form of a M2M (Machine to Machine) system which invokes a service discovery protocol 25 (SDP) in order to identify the capabilities of the network node as service provider. Such capability details are for instance service cost details, security restrictions, availability of service, format of data delivery or accuracy. The invoke comprises the steps of the network system transmitting 26 a service discovery protocol request to the network node via the network and the network node transmitting 27 a service discovery protocol response to the system via the network, the response containing information about the capabilities.

1-17. (canceled)

18. Method for informing a network about the capabilities of at least of network node, wherein an information element contains at least one predefined field comprising a parameter which defines a general characteristic of the network node,
wherein the network node processes at least one parameters being a role parameter relating to the capability and requirements of the network node in a role as an information provider, in said role forwarding information from a data storage and/or collecting unit to the network.

19. Method according to claim 18 wherein the processing consist in the defining of the role parameter.

20. Method according to claim 18 wherein the processing is activated when a data storage and/or collecting unit starts to communicate with the network node.

21. Method according to claim 18 wherein at least one role parameter defining the identity of the element is processed.

22. Method according to claim 18 wherein at least one role parameter defining the length of the element containing at least one role parameter is processed.

23. Method according to claim 18 wherein at least one role parameter defining the type of data storage and/or collecting unit is processed.

24. Method according to claim 18 wherein at least one role parameter defining the network resource or resources used by the network node for facilitating a better network utilization is processed.

25. Method according to claim 18 wherein at least one role parameter defining the service or services the network node can provide is processed.

26. Method according to wherein the processed role parameter is transmitted to the network.

27. Method according to claim 26 wherein the transmitted role parameter is processed by a network system to invoke a service discovery protocol in order to identify the capabilities of the network node as service provider.

28. Method according to claim 27 wherein invoke comprises the steps of:
the system transmitting a service discovery protocol request to the network node via the network, and
the network node transmitting a service discovery protocol response to the system via the network, the response containing information about the capabilities.

29. Method according to claim 27 wherein the transmitted role parameter is processed and the protocol is invoked by a machine to machine system.
